(19) United States
(12) Patent Application Publication
(10) Pub. No.: US 2018/0300770 A1
(43) Pub. Date: Oct. 18, 2018

(54) IN-SITU PREVIEWING OF CUSTOMIZABLE COMMUNICATIONS

(71) Applicant: Elateral, Inc., Westchester, IL (US)

(72) Inventors: Alexandre Perry Kamel, Castle Pines, CO (US); Peter Blackburn, Franham (GB)

(21) Appl. No.: 15/767,916

(22) PCT Filed: Oct. 12, 2016
(86) PCT No.: PCT/US16/56580

§ 371 Date: Apr. 12, 2018

Related U.S. Application Data
(60) Provisional application No. 62/284,868, filed on Oct. 13, 2015.
(60) Provisional application No. 62/407,189, filed on Oct. 12, 2016.

(51) Int. Cl. G06Q 30/02; H04N 21/81

(52) U.S. Cl. CPC G06Q 30/0276; H04N 21/812; G06Q 30/0281

(57) ABSTRACT

An in-situ communication customization system and process are described. The communication customization system and process can be implemented to create a communication based on previewing the communication in context of where the communication will be displayed. Typically, a smart device can be implemented to generate a live image of where the communication will be placed, and then integrating a graphical representation of the communication with the live image of the display location. The communication can then be altered based on design options, with the smart device re-rendering the graphical representation of the communication based on alterations by a user.

### CROSS-REFERENCE TO RELATED APPLICATION

This application claims the benefit of U.S. Provisional Application No. 62/284,868, filed Oct. 13, 2015, and U.S. Provisional Application No. 62/407,189, filed Oct. 12, 2016.

### BACKGROUND

Individuals involved in the design, production, delivery and/or analysis of communications understand that the more targeted and relevant the communications are to an intended audience, the more likely the advertising materials are to resonate with the targeted audiences. As a result of resonating with the targeted audience, the advertising materials are more likely to achieve desired or intended outcomes. Communications that are relevant and engaging for target audiences or individuals are known by those in the field to be more effective in achieving the objectives associated with such communications.

In order to create more relevant and engaging communications, which are more precisely targeted to individuals, markets, or segments thereof, it is currently common to customize or adapt communications by changing or adjusting the size, shape, look, feel, layout, language, imagery, artwork, photography, color, brightness, text, copy, content, and/or various other attributes of the communication.

Currently, such customizations occur by manipulating static digital versions of the advertising materials via electronic devices such as computers, laptops, tablets, and smart-phones. Further, the static digital versions of the advertising materials do not include a graphical representation of where the finalized communication material will be displayed. As such, communication materials are not designed with a location of where the communication material will be displayed in mind. More importantly, a designer does not make design choices based on real world conditions surrounding a specific location where the communication material will be displayed. Even when a display location is incorporated into the design process of a communication material, at best, a single photo is used to show the display location. Therefore, current marketing design strategies are limited to designing communication materials based solely on the communication material, or at best, including a single photograph of the design location that does not incorporate surrounding conditions of the display location. Current practices inhibit the enhancement or optimization of the design of the communication materials to best fit the intended communication location or point of delivery or consumption of such communication.

### BRIEF DESCRIPTION OF THE DRAWINGS

FIG. 1 is a flow chart of an in-situ communication customization process according to one embodiment of the present invention.

FIG. 2 is a block diagram of an in-situ communication customization system according to one embodiment of the present invention.

FIG. 3 is a graphical representation of an in-situ communication customization system and process according to one embodiment of the present invention.

FIG. 4A is a graphical representation of an in-situ communication customization system and process according to one embodiment of the present invention.

FIG. 4B is a graphical representation of an in-situ communication customization system and process according to one embodiment of the present invention.

### DETAILED DESCRIPTION

Embodiments of the present invention include a method and system for creating, modifying, and/or finalizing a communication template in-situ where the communication will be displayed. The system and method can be implemented to preview, customize, and store a communication template based on viewing a graphical representation of the communication where the communication will eventually be displayed. The system can typically include, but is not limited to, a smart device having a camera and an application running on the device. The method can include a process for implementing the system to create, modify, and/or finalize a communication template in-situ where the communication will be displayed.

As can be appreciated, embodiments of the present invention can be implemented in the fields of marketing, advertising, and/or sales. Two-dimensional communications and/or three-dimensional communications can be created, updated, reviewed, approved, ordered for production on location, and/or finalized. The communications can include, but are not limited to, electronic or virtualized materials and tangible communications or displays that may be used for marketing, advertising, sales, or other such promotional communication and messaging purposes.

In some instances, embodiments of the present invention may be used in connection with the customization of retail marketing and sales, shopper marketing, point of sale (POS) or point of purchase (POP) marketing, event marketing, or other on-premises marketing and communications purposes. The present invention may also be used in connection with the customization of online and other digital or electronic communications and marketing materials, including websites, mobile devices (including smartphones and/or tablets), digital displays, and the like.

In one embodiment, the method can enhance the process of making and provisioning a customized communication by implementing a step whereby a communication template may be previewed or visualized in-situ via the smart device as an integral part of the customization process. By making use of the camera of the smart device, an individual customizing the communication can take a visual image of (a) a display location (i) where the communication will be placed (e.g., a photographic or video image of a physical location including, but not limited to, a wall, a window, a shelf, an end-cap, a digital display panel, a promotional kiosk, or other such locations), or (ii) where the communication may be placed, or (b) a representation, image, or photograph of a web-page, social page, mobile application page or other desired location for the communication. Hereinafter, the term “context” will refer to a general location where the communication is to be placed, whether online or offline, whether a 2-dimensional surface or a 3-dimensional spatial location. The term “display location” will hereinafter refer to a more precise area where the communication will be displayed. For instance, the context may refer to a particular store and the display location can refer to a window of the store (or a digital display panel, or other surface in the store) where the communication will be displayed. The term “communication location” will hereinafter refer to a specific area, typically defined by the user when viewing the display location on a smart device, where the communication will be placed.

In one embodiment, the application can be configured to recommend one or more communication templates after analyzing the display location. For instance, the camera of the smart device can generate an image, whether live or a static image, and the application can then ascertain, based on machine-discernable characteristics of the display location, retrieve and recommend or provide a range of options for potential communication templates which may be relevant to and/or suitable for communication within the context or display location. For example, if viewing a live image of the context or display location or a static image thereof, the application may discern that the context is a wall or window. The application may then provide recommendations for wall or window posters. Similarly, if the context or display location is identified as a retail end-cap location, the application may then present various suitable three-dimensional display units, shelf strips, or other sorts of communications that are available and deemed appropriate for such locations.

After the smart device has generated a visual representation of the context, a visual representation, image, or preview of the communication can be superimposed onto or graphically overlaid onto the image or representation of the context. As can be appreciated, this effect may be achieved by a variety of methods, including graphic manipulation, digital image processing, augmented reality, and other similar technologies.

In one embodiment, the in-situ visualization of the communication within the context can be done in real time. For instance, the camera of the smart device can be pointed toward the context to view the context area live via the display of the smart device. As can be appreciated, the customization of the communication may be done in non-real time. For instance, a photograph of the context can be taken or otherwise captured as an image and then superimposing or inserting an image of the communication.

Typically, while previewing the communication in-situ, one or more properties or parameters of the communication template may be manipulated in order to achieve a desired effect. Parameters can include, but are not limited to, size, shape, look, feel, background color, or any number of design elements. For instance, a user may alter one or more parameters to customize and to optimize the communication template within the context where the communication will be displayed. In one example, size and shape may be adjusted to precisely fit the communication within available wall or window space, or onto a digital display panel. In another example, colors may be adjusted to enhance contrast with surrounding materials. In yet another example, in an instance of a 3-dimensional communication, like marketing displays, end-cap displays, floor stands, table top displays and the like, the communication may be visualized as if in-place to optimize the overall size and orientation of the communication template and to ensure spacing surrounding the communication as well as the overall dimensions, look, and feel achieve a desired effect.

In one embodiment, the process of customizing communications and previewing them in-context may be a simple one-time event. For instance, a user can visualize a completed communication in-situ. In another embodiment, the process may be an iterative or interactive process of customizing, previewing, further customizing, and previewing successive iterations, until completing the communication. The process of iterative customization may be conducted by one or more individuals through iterative manual interactions, or the customization may be conducted in an automated fashion via an intelligent data-enabled machine or computer driven automation. In one instance, the iterative customization may be conducted in a semi-automated fashion via machine or computer assisted interactions with one or more individuals.

In the instance of manual or semi-automated customization, the in-situ preview capability can allow for iterative refinement based on contextual previewing in relation to the achievement of a design intent or objective. In the instance of automated processing, the preview capability described herein may generate input which may be received or discerned by a machine or processing platform, and such input or information may be processed by such platform to achieve desired, specified intentions, or objectives. A combination of subjective previewing or visual inspection and automated processing of feedback information may be utilized as part of one process. Many such manifestations of manual, semi-automated, or fully automated methods may be envisioned by those skilled in the art, and all are intended to be included within the scope of the present invention.

The customization process can further contemplate and include in-situ previews or visualizations which may be viewed from one or more vantage points in the context. For example, a direct facing preview with no angular deflection, or a view from the sides, top, bottom, back, and so on of the communication in the context. As can be appreciated, this capability allows communications to be examined from various points of observation throughout an intended context. In the case of a retail store location, for example, previewing a poster in a window from in-front of the poster allows one to examine the content as displayed in-situ on the poster. Whereas previewing the poster in the window from behind allows one to preview the impact that such poster may have in obstructing the view through the window from inside the retail location. There are many such examples where visualizing customized communications from various aspects or reference points may be advantageous.

Of note, a designer customizing a communication template in-situ can take into account surrounding conditions when previewing the communication. In the instance of the store window display location, the designer may move to inside the store, while still viewing the display location on the smart device, to see how the poster may affect an inside of the store. As can be appreciated, the designer can make alterations to the communication template based on the surrounding conditions. Prior methods of customizing communications did not allow for a designer to immerse themselves in the conditions of where the communication would be displayed. The designer may move the smart device to any angle or location in the proximity of the display location to view how the communication looks from various angles.

Embodiments of the present invention encompass the ability to dynamically adjust an aspect ratio and a perspective of the communication based on the spatial orientation or angular deflection of the viewing or previewing angle of the smart device in relation to the context.

In order to determine the actual dimensions of a communication, which may be required in order to provision materials of appropriate size to manufacture the communication, a size reference, a measurement scale, or a rule of known dimensions may be applied within the context. As can be appreciated, when viewing the context via the camera of the smart device, the measurement reference can be captured to provide a means for the smart device to calculate size proportions between the context and the communication. Determination of an appropriate size for the communication may then be completed relative to the measurement reference. As such, the physical dimensions of communication may be determined so as to fit within the context and provide dimensional information to a manufacturer of the communication.

As can be appreciated, there is a plurality of conceivable means for determining the physical sizing or dimensions of a communication. As previously mentioned, the use of a measurement reference including, but not limited to, inserting a yard-stick, a box of known dimensions, or other such reference objects of known dimensions in the context are contemplated. Other methods contemplated within the scope of the present invention can include, but are not limited to, geometric algorithms based on a location of the smart device relative to the context, the use of laser measurement tools, optical techniques making use of camera viewfinders, and image processing methods, manual inputting of dimensions, and the like.

During the process of customizing communications in-situ, it can be desirable to capture or record information regarding the customization process, intended objectives, design considerations, rationale underpinning a particular customization of a communication, special instructions, or other information which may be useful for purposes of designing, reviewing, and approving, producing, delivering, and/or deploying, or sharing or otherwise processing a communication. In one embodiment, capturing of audio, voice recording, video, audio-visual, text-based information, and/or other data can be included with the customized communication. The captured information can be included in order to record pertinent information associated with the customization of the communication.

The recorded information associated with each customized communication, in whichever media and format, can generally be referred to herein as a linked message or linked messages. A combination of a communication and a linked message can generally be referred to herein as a bundle. A combination of a bundle and any other associated information relating to the customization of the communication including, but not limited to, other bundles, can generally be referred to herein as a payload.

A payload can typically include all desired linked messages associated with a particular communication, while resolution of specific bundles can allow for controlled routing of information to desired recipients of various bundles.

While customizing or previewing a communication via the application on the smart device, the application can include a process for creating linked messages by initiating one or more recordings and automatically associating the recording(s) with the communication. For example, a linked message may be associated with a communication for purposes of reviews and approvals. Another linked message may be associated with the communication for purposes of providing production specifications. Yet another linked message may be associated with the communication for purposes of providing installation instructions. As can be appreciated, several other scenarios may be intuited by those skilled in the art, and all such scenarios are contemplated within the scope of the present invention.

In one embodiment, the application can include user inputs for associating a linked message with a communication by a user action. For example, on recording or otherwise capturing a linked message during the process of completing, iterating, or previewing an in-situ communication, a user may select a check-box, list item, radio button, creating a graphic connection, or other such visual or text based mechanism to designate an intended purpose of the linked message. The information may then be used for purposes of creating one or more bundles for distribution to one or more destinations in support of design, approval, production, delivery, and/or installation.

Once the customization of the communication is completed, a snapshot or image of the communication in-situ can be captured or recorded. For instance, the application can include a screen capture function or other known image capturing function. The captured image of the in-situ communication can generally be referred to herein as a snapshot. The snapshot may then be used for a variety of purposes, including, but not limited to, routing for review and approval of the communication, routing with a production order to complete the design, production, or delivery of the communication, archiving, sharing with others who may have similar need of the communication, or other similar purposes associated with the design, approval, production, provisioning, installation, or fulfillment of customized communications. A Snapshot may be included within one or more bundles, or may be included within a payload independent of the bundles.

Embodiments of the present invention include several benefits over currently available means of creating communications. By enabling in-situ visualization of the communication from one or more vantage points, the communication may be better optimized to achieve a desired effect, while better anticipating and avoiding undesirable or unintended design consequences. The communications may be better differentiated across multiple locations based upon location or context-specific considerations, thereby creating more relevant and engaging experiences and communications across a range of contexts. The customized communications may also be optimized for each particular context. For example, a customized poster for a window display may not translate effectively into a web page layout for display on a webpage. Embodiments can enhance an ability to preview with improved visualization and sizing capability, the overall aesthetic appeal and physical (or digital) dimensions of the communications may be improved. For example, the customization of the communications may reduce the incidence of communications that seem out of place, communications that clash with their surroundings in undesirable ways, communications that obstruct site lines, or communications that do not fit available or intended dimensions. Embodiments may improve an ability to preview in-situ issues including, but not limited to, errors and unanticipated problems or undesired effects. Such issues may be proactively identified and avoided, significantly reducing waste and rework. As can be appreciated, by automating the ability to preview in-situ, the communications may be designed, approved, produced, and deployed more quickly, effectively, and efficiently.

Embodiments can enable simple and expedient capturing of linked messages for various workflow purposes and can associate the linked messages with a particular customized communication. By managing distribution of the linked messages based on bundles and payloads, workflow steps and related collaborations associated with the in-situ customization of the communication can be greatly simplified, accelerated, and made more efficient and effective. The use of snapshots may further improve the efficiency and effectiveness of related workflows. As can be appreciated, the use of bundles, payloads, and/or snapshots may establish a strong foundation for management of governance, accountability, service level management, warranty, and other such process management activities. For example, a merchant may approve a communication for placement within a store window. In such an example, the payload, which may include one or more snapshots, one or more linked messages, and other pertinent information, may be retained as part of an order or record for reference purposes.

Components of the present invention can be embodied as devices, systems, methods, and/or computer program products. Accordingly, the present invention can be embodied in hardware and/or in software (including firmware, resident software, micro-code, etc.). Furthermore, the present invention can take the form of a computer program product on a computer-usable or computer-readable storage medium having computer-usable or computer-readable program code embodied in the medium for use by or in connection with an instruction execution system. In one embodiment, the present invention can be embodied as non-transitory computer-readable media. In the context of this document, a computer-usable or computer-readable medium can include, but is not limited to, any medium that can contain, store, communicate, propagate, or transport the program for use by or in connection with the instruction execution system, apparatus, or device.

The computer-usable or computer-readable medium can be, but is not limited to, an electronic, magnetic, optical, electromagnetic, infrared, or semiconductor system, apparatus, device, or propagation medium.

The following PCT applications are incorporated by reference in their entirety: PCT/US14/32996, filed Apr. 4, 2014, titled “MULTI-CHANNEL QUEUING”; PCT/US14/31403, filed Mar. 21, 2014, titled “MULTI-TEMPLATE KIT SYSTEM AND PROCESS”; PCT/US14/20694, filed Mar. 5, 2014, titled “TEMPLATE METADATA”; PCT/US13/62971, filed Oct. 2, 2013, titled “CONTENT ANALYTICS”; and PCT/US15/19617, filed Mar. 10, 2015, titled “MARKETING DISPLAY CUSTOMIZATION SYSTEM AND PROCESS”.

Of note, embodiments of the present invention can be implemented with the inventions disclosed in each of the previously mentioned applications incorporated by reference. In particular, embodiments of the present invention can be implemented with the teachings of the “Multi-Template Kit System and Process” application. For instance, an assortment of various surfaces or objects, whether real and/or virtualized, in any combination, can be painted with the content concurrently. For example, the snapping of content to the various items/objects/surfaces can be done in batch mode.

### Terminology

The terms and phrases as indicated in quotation marks (“”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

The term “software,” as used in this specification and the appended claims, refers to programs, procedures, rules, instructions, and any associated documentation pertaining to the operation of a system.

The term “firmware,” as used in this specification and the appended claims, refers to computer programs, procedures, rules, instructions, and any associated documentation contained permanently in a hardware device and can also be flashware.

The term “hardware,” as used in this specification and the appended claims, refers to the physical, electrical, and mechanical parts of a system.

The terms “computer-usable medium” or “computer-readable medium,” as used in this specification and the appended claims, refers to any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

The term “signal,” as used in this specification and the appended claims, refers to a signal that has one or more of its characteristics set or changed in such a manner as to encode information in the signal. It is to be appreciated that wireless means of sending signals can be implemented including, but not limited to, Bluetooth, Wi-Fi, acoustic, RF, infrared and other wireless means.

The terms “content analytics” or “asset analytics,” as used in this specification and the appended claims, refer to an assessment and characterization of an asset's demonstrated capacity to contribute to an effectiveness of a communications initiative under a variety of communications contexts with regard to an achievement of a variety of desired outcomes, whether for discrete initiatives, types of initiatives, or cumulative impact across all initiatives where the asset has participated over a span of time.

The term “communication,” “communications,” or “communication material” will be used herein to refer generally to any and all such forms of customizable communications and advertising, and to the materials used for such communications, whether online, offline, 2-dimensional, or 3-dimensional.

### A Method of Customizing a Communication In-Situ

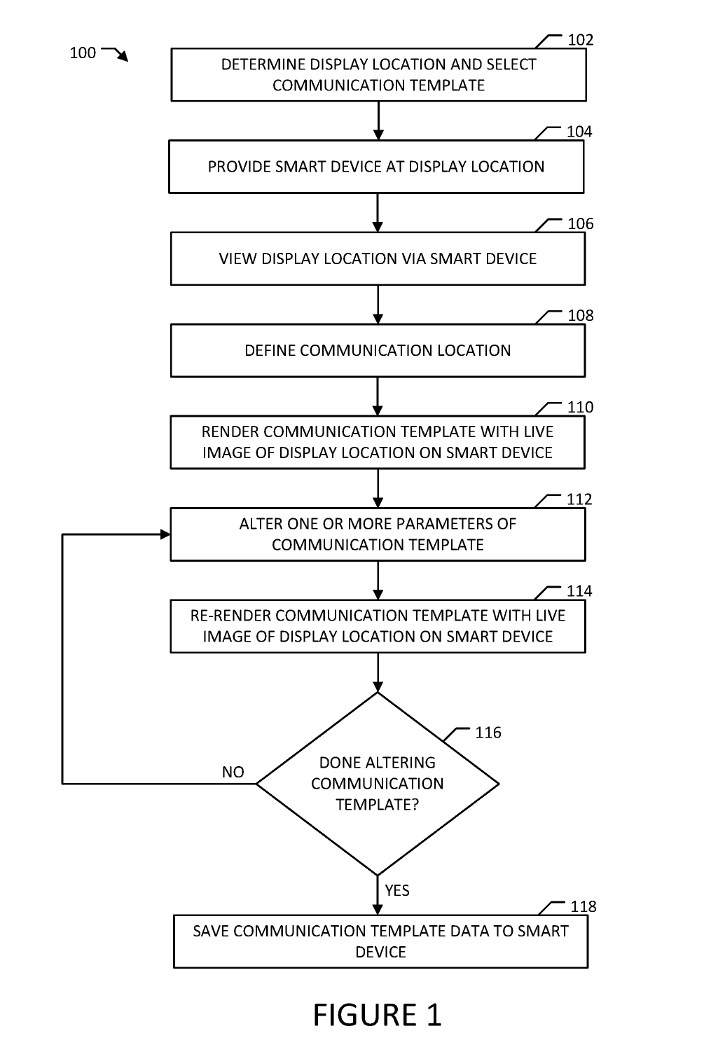

Referring to FIG. 1, a flow chart of a method or process 100 for customizing a communication in-situ is illustrated. The process 100 can be implemented to customize a communication template while viewing the communication template in-situ and making/viewing changes to the template based on viewing the communication in a context where the communication will be placed.

In a block 102, a user can determine a display location to place a communication. In one instance, the user can select a communication template based on the display location. For example, the user may have a predetermined display location and may select one or more communication templates based on the display location. As an example, the user may select a billboard communication template for a communication that will be displayed on the side of an interstate on a billboard. In another instance, the user may select a display location based on a predetermined communication template. For example, the user may prefer a particular design of a communication template and may then select a display location based on properties of the communication template.

After the user has determined the display location and the communication template, the process can move to a block 104. In the block 104, the user can provide a smart device at the display location. The smart device can typically include at least a touch display, storage, a processor, and a camera.

In a block 106, the user can implement the camera of the smart device to provide a digital image of the display location on the touch display of the smart device. In one instance, the digital image can be a live image or a live feed of the display location. Hereinafter, the term “live image” will include both a live still image of the display location and a live video feed of the display location.

In a block 108, the user can define an area of the live image of the display location as a communication location. The communication location can be an approximate area of where the communication will be placed. For instance, the user can define an area on a store window where a poster communication will be displayed. In one example, the user can define the area by implementing virtual markers on the display screen. The smart device can include a touch display where the user can touch different parts of the display screen to indicate where the virtual markers should be placed. The smart device can then use the virtual markers to denote the area where the communication template will be placed.

In a block 110, the smart device can be implemented to render the communication template within the live image of the display location. As can be appreciated, the user would be able to view the communication template at a location where the communication is to be displayed. In some embodiments, the process 100 can skip the block 108 and move directly to the block 110. In such an embodiment, the user can move a graphical representation of the communication template on the display to a location of where the communication will be displayed. Generally, the user can then pin the communication template in place. For instance, if the user moves the smart device around effectively changing the live image of the display location, the communication template can stay in place. As an example, the user may move back from the display location to get a wider view, the communication template would stay in place.

In a block 112, while viewing the communication template at the display location, the user can adjust one or more parameters of the communication template based on viewing the communication template at the display location.

In a block 114, the smart device can be implemented to re-render the communication template on the touch display based on the one or more parameters being adjusted. For example, the user may adjust a size parameter of the communication template to better fit within the display location.

After the communication template has been re-rendered based on altered parameters, the process can move to a decision block 116. In decision block 116, the process can determine if the user is done altering the communication template by receiving input from the user. If the user indicates that no more alterations are needed for the communication template, the process 100 can move to block 118. In the block 118, the finalized communication template can be saved to the storage of the smart device. In one instance, data pertaining to the finalized communication template can be sent to one or more users for approval and/or review.

If the user indicates that the communication template is not finalized, the process can return to block 112 and repeat until the user is done altering the communication template. As can be appreciated, work in progress can be saved during any given point in the process to enable resumption of activities following a period of time. The communication template can generally be saved to the smart device. In another instance, the communication template can be transferred to and saved on an alternative device. For instance, network servers, cloud storage, or other such storage mechanisms via wireless or other transfer mechanisms can be implemented to save the communication template.

### An Embodiment of an In-Situ Communication Customization System

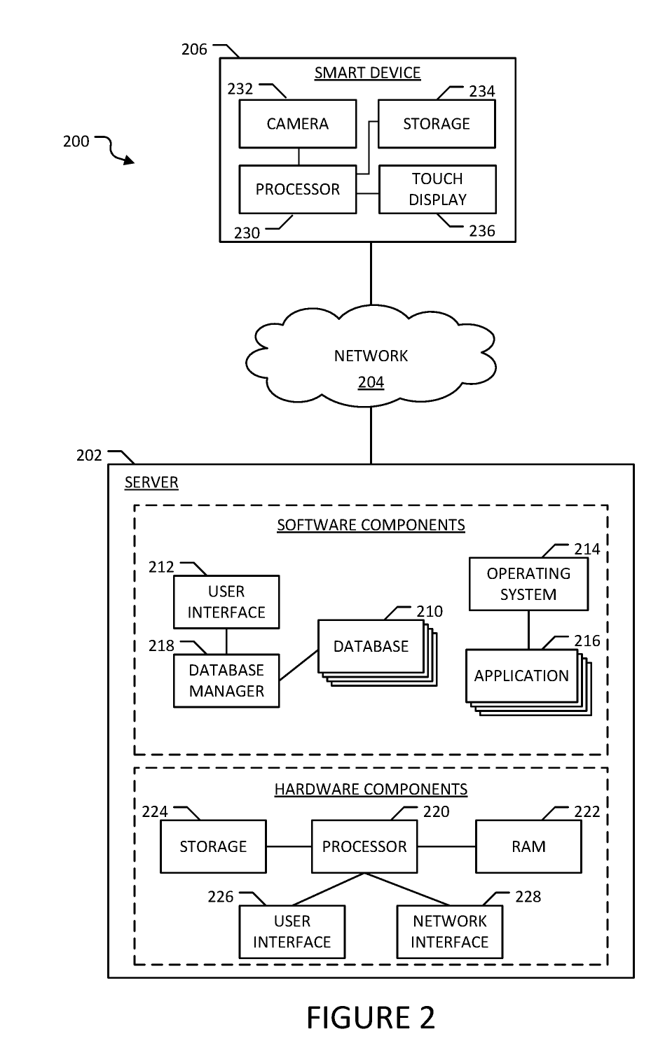

Referring to FIG. 2, a detailed diagram of an embodiment 200 showing an in-situ communication customization system is illustrated. The in-situ communication customization system 200 can be implemented to create a communication based on viewing the communication at a location where the communication is to be displayed.

Generally, the in-situ communication customization system 200 can include a server 202, a network 204, and a smart device 206.

The server 202 can represent a server or another powerful, dedicated computer system that can support multiple user sessions. In some embodiments, the server 202 can be any type of computing device including, but not limited to, a personal computer, a game console, a smartphone, a tablet, a netbook computer, or other computing devices. In one embodiment, the server 202 can be a distributed system wherein server functions are distributed over several computers connected to a network. The server 202 can have a hardware platform and software components.

The software components of the server 202 can include the one or more databases 210 which can store the plurality of communication templates. The software components can also include an operating system 214 on which various applications 216 can execute. A database manager 218 can be an application that runs queries against the databases 210. In one embodiment, the database manager 218 can allow interaction with the databases 210 through an HTML user interface on a user device 206.

The hardware platform of the server 202 can include, but is not limited to, a processor 220, random access memory 222, and nonvolatile storage 224. The processor 220 can be a single microprocessor, multi-core processor, or a group of processors. The random access memory 222 can store executable code as well as data that can be immediately accessible to the processor. The nonvolatile storage 224 can store executable code and data in a persistent state.

The hardware platform can include a user interface 226. The user interface 226 can include keyboards, monitors, pointing devices, and other user interface components. The hardware platform can also include a network interface 228. The network interface 228 can include, but is not limited to, hardwired and wireless interfaces through which the server 202 can communicate with other devices including, but not limited to, the smart device 206.

The network 204 can be any type of network, such as a local area network, wide area network, or the Internet. In some cases, the network 204 can include wired or wireless connections and may transmit and receive information using various protocols.

The smart device 206 can be any type of computing device on which a browser can operate. Examples of such devices can include, but are not limited to, desktop computers, laptop computers, tablet computers, mobile telephones, game consoles, network appliances, or any other web-enabled devices. In an embodiment, the smart device 206 can have various hardware platforms on which a browser can execute. The browser can be used to access the HTML user interface of the database manager 218. In one instance, the system can execute functional operations by virtue of service calls to a service-based processing system.

Typically, the smart device 206 can include, but is not limited to, a processor 230, a camera 232, a non-transient storage 234, and a display 236. Typically, the display 236 can be a touch display configured to receive input from a user. In one instance, the smart device can include a user interface similar to the user interface 226 of the server 202 for receiving input from the user.

In one embodiment, a plurality of communication templates can be stored in the server 202. For instance, the plurality of communication templates can be stored in the one or more databases 210. It is to be appreciated that the plurality of communication templates can be stored externally to the server 202. For instance, the databases 210 can be remotely located from the server 202. Typically, a user can access the database 210 and search for a predetermined set of communication templates ideal for a particular context. For instance, the database 210 can be accessed through a web interface. In another instance, the user can have direct access to the database 210. For example, the server 202 can include a user interface or web based interface 212 to access the database 210.

In one embodiment, the in-situ communication customization system 200 can include a communication template customization program. Generally, the communication template customization program can be implemented as an application. It is to be appreciated that the application can be embodied on a variety of computing devices. For instance, the communication template customization application can be embodied on the smart device 206. In one embodiment, the communication template customization program can provide access to the communication template database 210.

In a typical implementation, a user can run the communication template customization application on the smart device 206 to access the communication template database 210 and create a communication on location where the communication will be displayed. The communication template customization application can be implemented to design a communication by allowing a user to view a rendering of the communication in-situ where the communication will be displayed.

In one embodiment, the smart device 206 can be connected to the remote server 202 via the network 204 and can receive data related to the communication templates from the remote server 202. For instance, the smart device 206 can access a communication template database of the server 202 and retrieve one of a plurality of communication templates stored in the template database. As such, the communication templates can be remotely accessed and customized. Typically, in such an embodiment, the smart device 206 can be configured to locally store a copy of any alterations to the communication template while the communication template is being customized. Further, while the smart device 206 is connected to the network 204, the smart device 206 can save data related to the customized communication template to a remote server or database. In another embodiment, the smart device 206 can operate substantially in a similar manner, but can download and store related data to the communication template locally on the non-transient data storage 234. For instance, the smart device 206 may still customize a communication template without access to the network 204.

Generally, a user can know a location of where the communication will be displayed. Based on the display location, the user can select one of a plurality of communication templates to view at the display location. As can be appreciated, the user may select a plurality of communication templates to view at the display location. In such an instance, the application can store data related to each of the selected communication templates in the storage 234 of the smart device. Alternatively, the user may select a communication template and determine a display location based on the communication template.

In one embodiment, the application can present the user with one or more communication templates to choose from after the customization application is initiated. For instance, the communication template customization application can present one or more communication templates based on a few initial inquiries. In another instance, the application may suggest, recommend, or provide suitable options based on characteristics of the intended display location. In one example, the communication template customization application may determine a general category of communication templates to be selected and present communication templates that have been predetermined to match with the general category of the display location. It is to be appreciated that other means of presenting an initial set of communication templates is contemplated.

Typically, after a user has taken the smart device 206 to where the communication will be displayed, the user can start the communication template customization application. The application can initiate the camera 232 of the smart device 206 to generate a live image of the location where the communication will be displayed. After the camera 232 has been initiated, the user can view a live image or video feed of the display location on the display 236 of the smart device 206.

After selecting a communication template, the communication template customization application can analyze information included with the communication template and determine which rules and constraints to apply when combining the communication template with the live image of the display location. Typically, each communication template can have a set of predefined rules that govern the communication template and how the communication template may be rendered graphically on a display. For instance, the predefined rules may include dimensions for the communication template. It is to be appreciated that a variety of rules can be predefined for each communication template. It is to be appreciated that the process may be linear, or may be executed in a parallel or iterative fashion.

The processor 230 of the smart device 206 can then be implemented to render an image or graphical representation of the selected communication template into the live image of the display location. The user can then view the communication template as the communication would appear when placed at the display location. In one embodiment, the application can allow the user to select an object or area in the live image to be designated as the communication location. For instance, if the communication will be displayed in a window of a store front, the application can allow the user to determine a location on the window of the store front to be the communication location. The rendering of the communication template with the live image of the display location will hereinafter be referred to as the “combined image”. Generally, the processor 230 can be configured to render the communication template approximate the area selected by the user as the communication location.

Generally, the communication template can include one or more parameters for defining how the communication template will graphically be rendered and displayed by the application. In one instance, the application can include one or more interactive icons displayed with the combined image allowing the user to alter the one or more parameters of the communication template while viewing the communication template in-situ. In another instance, the application can include an interactive icon that when selected brings up each of the one or more parameters and allows the user to alter each of the one or more parameters.

While viewing the combined image, the user can determine if any changes need to be made to the communication template. If changes are needed, the user can alter one or more parameters associated with the communication template. For instance, the user may alter a dimensions parameter to enlarge or reduce a size of the communication template in relation to the display location. After the user has altered at least one parameter, the application can implement the processor 230 to re-render a graphical representation of the communication template with the live image based on the altered parameters. As can be appreciated, the application can re-render the communication template each time a parameter is changed to reflect the altered parameter in the graphical representation of the communication template.

After the user has finished customizing the communication template, the application can save all relevant data related to the communication template to the storage 234 of the smart device 206. In some instances, the application can automatically transfer data from the smart device 206 to another device or to the server 202.

As can be appreciated, during the process of customizing a communication template, the user may want to capture or record information regarding the customization process, intended objectives of the communication, design considerations, rationale underpinning a particular customization made by the user, special instructions, and/or other information that may be useful for purposes of designing, reviewing and approving, producing, delivering, and/or deploying the communication. For such instances, the application can be configured to capture audio, video, audio-visual, text-based information, and/or other data in connection with the in-situ customization process.

In one embodiment, the application can be adapted to receive ancillary information from a user and associate the information with the communication template being customized. Generally, the application can store the ancillary information in the storage 234 of the smart device 206. In one embodiment, the application can store the ancillary information in metadata of the communication template. In another embodiment, the application can create a new file for the ancillary information and associate the information with the communication template. For instance, the application can create a folder including the communication template and an individual file for each piece of information created by the user.

In one instance, the application can record verbal remarks from the user. For example, while viewing the combined image, the user may record a verbal remark indicating that that the user believes the communication template needs to have a different background color due to the amount of sunlight the display location receives. In another example, the user may type a message for a manufacturing company that the communication template, when manufactured, needs to be made from weatherproof material as the communication will be subjected to the weather. As can be appreciated, the examples previously mentioned are for illustrative purposes only and not meant to be limiting.

### Example Implementation of the In-Situ Communication Customization System

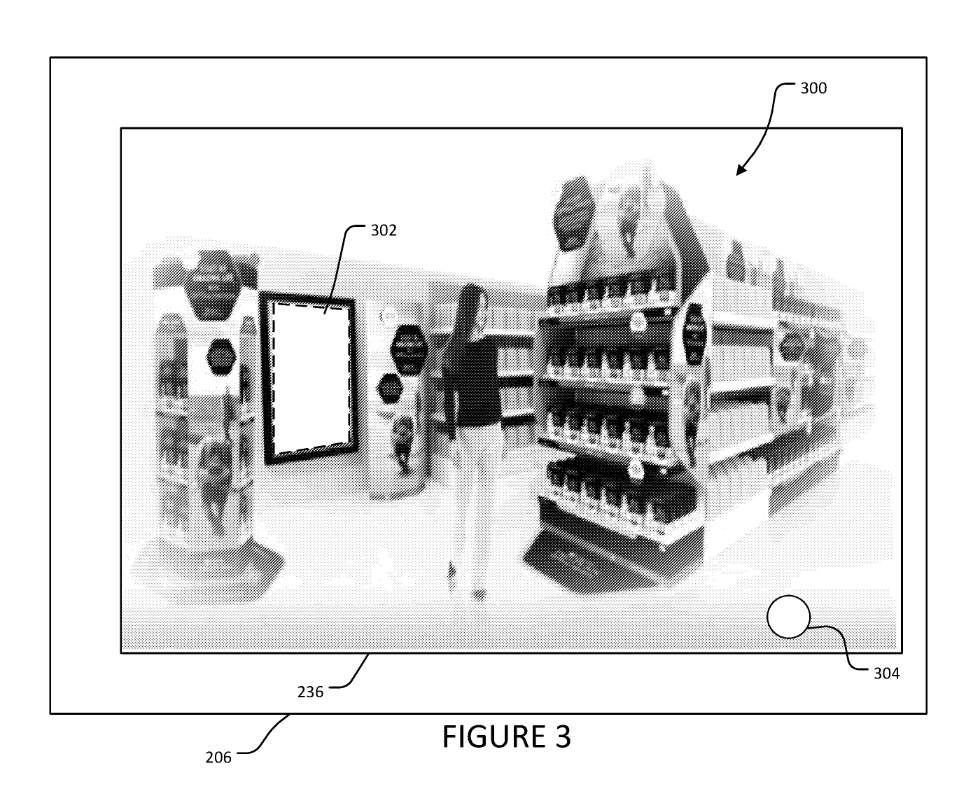

Described hereinafter is one example of implementing the in-situ communication customization method with the system. Referring to FIG. 3, a detailed diagram of a display location 300 viewed through the display 236 of the smart device 206 is illustrated.

As can be appreciated, a user may take the smart device 206 to a location where the communication will be displayed. In this example, the communication will be a poster located on a wall in a convenience store. The display location 300 can encompass the wall where the poster will be displayed along with the vicinity approximate the wall. For instance, the entirety of the store can be taken into account when customizing the poster to be displayed on the store wall.

Once the user has taken the smart device 206 to the display location 300, the user can view the display location 300 via the camera 232 of the smart device 206. As shown, an image of the display location 300 can be shown in the display 236 of the smart device 206. Depending on an implementation, the camera can be initiated via the communication customization application. In such an implementation, the user can then select a communication template to view. For instance, the application may include an active icon 304 for allowing the user to view a plurality of communication templates. In another implementation, the user can have already selected the communication template, and the application can render the communication template in the application once the user selects to activate the camera 232. Once the communication template is selected, the processor 230 of the smart device 206 can combine or render a graphical representation of the communication template with the live feed of the display location.

As discussed previously, in some embodiments, the user can first define an area to be a communication location 302 that represents where the communication will be placed in the display location 300. As shown, the user can define the communication location 302 by borders of poster. When the user defines the communication location 302, the application can pin or place the communication template into that location on the live feed of the display location 300. As can be appreciated, the user can define a specific area of where the communication template will be placed.

In one embodiment, the application can include the one or more active icons 304 for bringing up adjustable parameters of the communication template. The adjustable parameters can be implemented to allow the user to customize the communication template to a particular display location. Embodiments are contemplated where the user may manipulate certain parameters of the communication template by selecting and dragging or similar touch interface interactions that are known to one of ordinary skill in the art.

As the user alters one or more of the adjustable parameters of the communication template, the application can be configured to continuously update a graphical representation of the communication template as displayed by the smart device 206. In another instance, the application can wait for confirmation from the user to implement any alterations to the parameters by the user. In yet another instance, the application may include automation of altering parameters of the communication template. For example, the user may select a communication template and the application may automatically adjust one or more parameters of the communication template based on characteristics of the display location. After the application has automatically altered one or more parameters, the customized communication template can be re-rendered with the live image of the display location.

Once the user has finished customizing the communication template, the application can save data and/or information related to the customized template in the non-transient data storage 234 of the smart device 306. Embodiments are contemplated where the finalized communication template can be sent from the smart device to one or more remote devices. In one example, the remote device may be an email client of a manufacturer that will be producing the actual communication from the communication template. In another example, the communication template may be sent to a plurality of remote devices for review and feedback on the customized communication template.

### A Method of Defining a Communication Location

A method or process can be implemented to define the communication location by using visual markers to denote a specific area as the communication location. In one embodiment, to define a precise area in the display location as the communication location, a plurality of markers can be placed on a surface where the communication is intended to be displayed.

In one embodiment, physical markers that can be placed on an object in the actual display location can be utilized. For example, identifiable colored stickers can be placed on the surface of a wall, window, floor, etc. Typically, the markers can include an adhesive for sticking to the object in the display location. The communication customization application can be configured to detect the markers when seen by the camera of the smart device. Typically, after the application has detected the markers and defined the communication location, any communication templates selected by the user can be automatically pinned to the area defined by the markers. For instance, the application can “snap” the communication template onto those markers. Such “snapping” can be content projected upon or applied (e.g., virtually in an in-situ preview) to either (i) physical/tangible objects (e.g. walls, coffee makers, countertops, trays, etc.) and/or (ii) display surfaces (e.g., projecting content onto a computer screen or a flat panel television display, or other such device). As can be appreciated, embodiments of the present invention can allow for in-situ visualization of electronic content in electronic media/electronic displays, in addition to visualizing printed materials like posters, decals, etc. on physical objects.

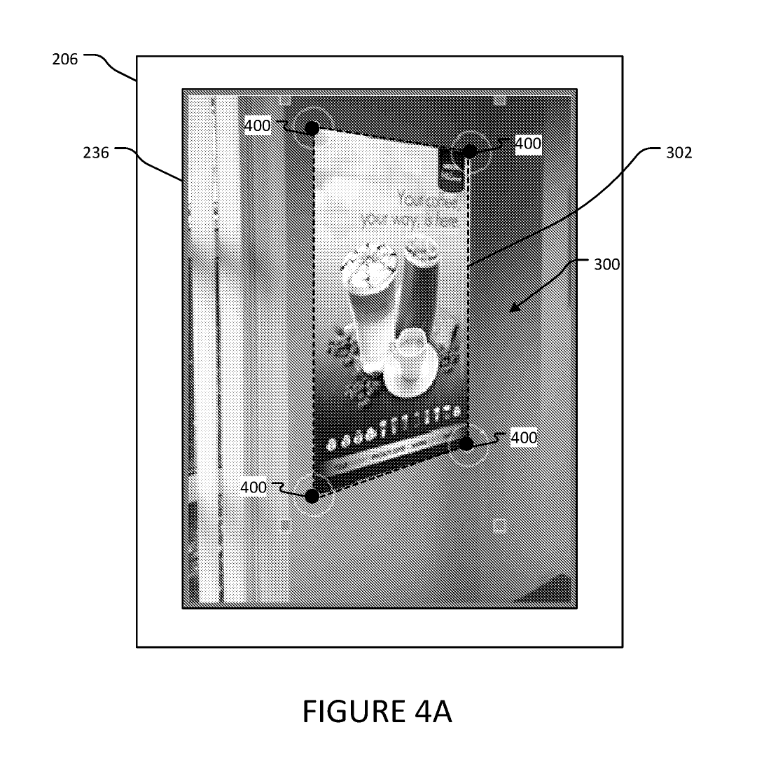

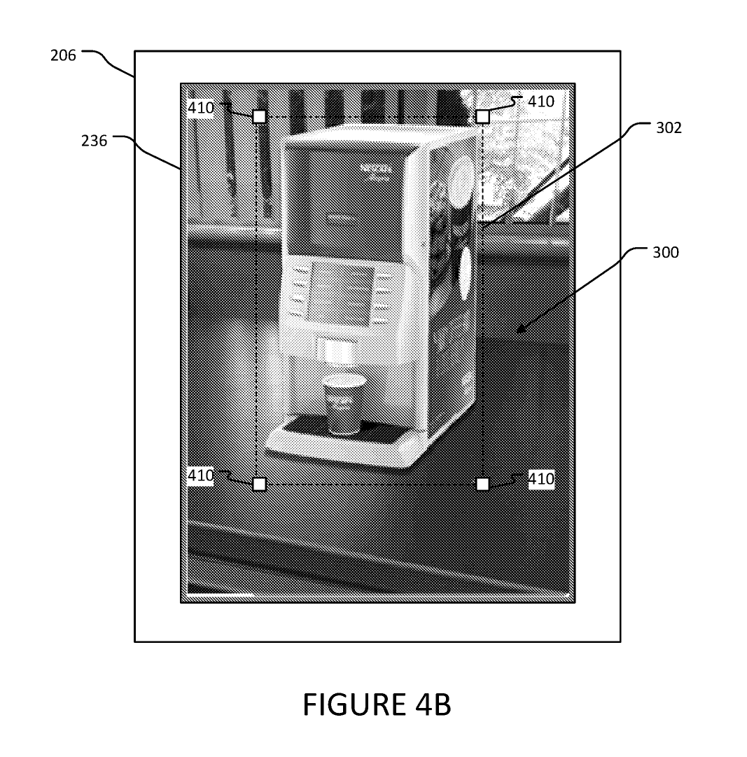

Referring to FIG. 4A, an example illustration of a plurality of physical markers 400 being implemented to define a communication location 302 is shown. As can be appreciated, a user may place the plurality of markers 400 on the wall shown on the display 236 of the smart device 206. The view shown on the display 236 can be of the display location 300, which includes the wall. Typically, the user can attach the four markers 400 to outline a roughly rectangular shape, as denoted by the communication location 302. For this example, the communication template can be a rectangular poster. As shown, the four markers 400 (or dots) can be placed on a wall surface roughly outlining a rectangular shape to denote the communication location 302 for each of four corners of the rectangular poster. As can be appreciated, the rectangular communication template (i.e., poster template) can then be snapped to the four corners defined by the plurality of markers 400.

In another example not shown, a first marker having a first color can be used to denote a center of a communication, and a second marker having a second color can be used to denote a radial location. In this example, the precise location of circular communication can be defined via the placement of the first marker and the second marker. Similarly, for the first mentioned example, a pair of markers may have a first color denoting a top of the rectangle and a pair of markers may have a second color to denote the bottom of the rectangle. In such an implementation, the application can correctly snap the communication template to the defined communication location.

Generally, the communication customization application can be configured to identify the markers and differentiate between differently colored markers. The application can be further be configured to determine how to treat differently colored markers. Several similar methods are envisioned and contemplated for specifying the communication location and for the automated positioning of related communication templates, and all are intended to be included in the scope of this disclosure.

In one embodiment, the automated “snap to” function can be implemented by physically applying green sticker dots to real (or tangible) surfaces and/or objects. In one example, a user can apply the green stickers to define an outline of an area to be the communication location. The communication customization application can then automatically snap a communication template selected by the user to the green dots on the surface or object on which the green dots were applied. The application can be configured to automatically render communication templates in a proper perspective since the application has defined an area to be the communication location. As can be appreciated, the application can automatically re-render the communication template if there is an aspect ratio alteration. For example, the user may move closer or further away from the display location, resulting in the communication template being resized and graphically re-rendered on the display of the smart device. As can be appreciated, the communication template can behave as if the communication template is part of that surface, with aspect ratio adjusting in harmony with such surface or object(s) as viewing orientation changes.

In another embodiment, one or more virtual markers can be placed in the display location shown on a display of a smart device, as defined by a user. Typically, the communication customization application can include an icon for defining the communication location. When the icon is selected by a user, the application can prompt the user to define the communication location by touching on the touch display where the markers should be located. The application can then determine a shape for the communication template by determining a general shape defined by the user. For instance, if the user selects four different locations for the markers, the application can determine a size and shape based on the four different locations.

Referring to FIG. 4B, an example illustration of a plurality of virtual markers 410 being implemented to define a communication location is shown. A graphical representation of a coffee maker template is illustrated within the display location 300 with graphical representations of the four virtual markers 410. As previously mentioned, the application can implement virtual markers 410 to define the communication location 302. For instance, digital representations of the color dots can be placed on an image generated by the camera 332 of the smart device 306 by the touch display 336. For example, the dots can be virtualized when a user touches a surface or an object on the display and the application renders a green dot where the user touched the display screen with a finger or a stylus.

In one embodiment, where communications will be placed on three-dimensional objects, a virtual representation of the three-dimensional object can be rendered in the live view of the display location. The communication template can then be viewed with the three-dimensional object in instances where the object is not at the display location yet or will be placed there in the future. The coffee maker shown in FIG. 4B is not actually at the display location 300, but is a digital image that has been rendered based on the selection of four virtual markers 410 by a user. Of note, the markers 410 can be applied to a right side surface of the coffee machine as viewed face-on. The application can then snap the coffee maker into place in proper perspective and the application can adjust perspective by rotating the graphical representation of the coffee maker. The graphic communication on a right hand side facing or right hand side surface of the coffee maker can also be snapped onto the surface of the coffee maker by means of similar application of virtual markers used to denote the desired location of the communications to be applied to the side surface of the coffee maker. Once the communication template has been virtually applied to the side of the virutualized coffee maker, the coffee maker can be repositioned within the field of view by clicking and dragging (or, in the case of a tablet, by touching and dragging) the image of the coffee maker. As the coffee maker is moved, either rotated or repositioned, the communication template which has been virtually applied to the side of the machine automatically moves with the coffee maker image as if it were physically applied to the side of the machine.

As can be appreciated, when either the physical markers are implemented or the virtual markers, the application can resize the communication template based on alteration of size parameters of the communication template. Stated alternatively, the communication location can be redefined while a user customizes the communication template. As can be appreciated, the processor 230 of the smart device 206 can re-render the communication template after each alteration to the communication template.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

It is to be appreciated that the above disclosed description provides one example of a particular manifestation of communication template metadata. Several schemas are possible, and the particular schema described herein is not meant to be exhaustive, nor is it intended to limit the scope of the present invention. Establishment and implementation of communication template metadata, regardless of various alternative schemas, is encompassed within the scope of the present invention.

1-30. (canceled)

31. A computer-implemented method for customizing a communication template at a display location, the method comprising:
selecting a communication template, the communication template including a set of adjustable parameters defining the communication template;
providing a smart device at the display location where a customized version of the communication template will be displayed, the smart device including:
a touch display;
non-transient data storage;
a processor; and
a camera;
viewing a live image of the display location on the touch display of the smart device captured by the camera of the smart device;
rendering a graphical representation of the communication template within the live image of the display location based on the set of adjustable parameters of the communication template;
altering one or more of the adjustable parameters of the communication template; and
re-rendering the graphical representation of the communication template within the live image of the display location based on the altered parameters of the communication template.

32. The computer-implemented method of claim 31, the method further comprising the step of:
defining an area within the live image of the display location as a communication location.

33. The computer-implemented method of claim 32, wherein the graphical representation of the communication template is rendered approximate the communication location.

34. The computer-implemented method of claim 33, wherein the graphical representation of the communication template is pinned to the communication location.

35. The computer-implemented method of claim of claim 34, wherein the communication template stays pinned to the communication location when the smart device is moved around changing the live image of the display location.

36. The computer-implemented method of claim 1, the method further including the steps of:
receiving ancillary data related to the communication template; and
associating the ancillary data with the communication template.

37. The computer-implemented method of claim 36, wherein the ancillary data is selected from the group consisting of audio, video, and text.

38. The computer-implemented method of claim 36, further comprising the step of:
storing the ancillary data and the communication template in the non-transient data storage.

39. The computer-implemented method of claim 31, wherein the customized communication template is sent to a manufacturer to produce the communication.

40. The computer-implemented method of claim 39, wherein the customized communication is sent to a second user for approval before being sent to the manufacturer.

41. The computer-implemented method of claim 31, wherein each time one of the adjustable parameters is altered data related to the communication template is stored in the non-transient data storage.

42. The computer-implemented method of claim 31, wherein the live image of the display location is a video feed from the camera.

43. A method for previewing a communication at a display location, the method comprising:
by a user, determining a location to be the display location;
by the user, providing a smart device in a vicinity of the display location, the smart device including:
a touch display;
non-transient data storage;
a processor; and
a camera;
by the user, starting a communication template customization application on the smart device;
by the application, initiating the camera to generate a live image of the display location on the touch display;
by the user, defining a communication location within the live image of the display location;
by the application, presenting one or more communication templates to the user based on (i) the defined communication location, and (ii) one or more characteristics of the display location;
by the user, selecting a communication template, the communication template including a plurality of adjustable parameters;
by the application, rendering a graphical representation of the communication template within the live image of the display location, the communication template being placed within the defined communication location;
by the user, altering one or more of the plurality of adjustable parameters of the communication template; and
by the application, re-rendering the graphical representation of the communication template based on the altered adjustable parameters.

44. The method of claim 43, the method further comprising:
by the application, automatically storing data related to the communication template in the non-transient data storage of the smart device.

45. The method of claim 43, the method further comprising:
by the application, automatically sending data related to the communication template to a remote server having a database and saving the communication template data in the database.

46. The method of claim 45, the method further comprising:
by a second user, querying the remote server to download the communication template data.

47. A computer-implemented method for customizing a communication template at a display location, the method comprising:
selecting a communication template, the communication template including a set of adjustable parameters defining the communication template;
providing a smart device at the display location where a customized version of the communication template will be displayed, the smart device including:
a touch display;
non-transient data storage;
a processor; and
a camera;
defining an area within the live image of the display location as a communication location.
viewing a live image of the display location on the touch display of the smart device captured by the camera of the smart device;
rendering a graphical representation of the communication template within the live image of the display location approximate the communication location;
altering one or more of the adjustable parameters of the communication template; and
re-rendering the graphical representation of the communication template within the live image of the display location based on the altered parameters of the communication template.

48. The computer-implemented method of claim 47, wherein the step of defining the communication location includes:
placing one or more markers on an object where the communication will be placed in the display location;
detecting the one or more markers with the camera of the smart device;
defining an area based on the configuration of the one or more markers;
wherein the graphical representation of the communication template is automatically rendered in the area defined by the one or more markers.

49. The computer-implemented method of claim 48, wherein the one or more markers include an adhesive to stick to the object.

50. The computer-implemented method of claim 47, wherein the step of defining the communication location includes:
inputting one or more virtual markers in the live image of the display location;
defining an area based on the configuration of the inputted one or more virtual markers;
wherein the graphical representation of the communication template is automatically rendered in the area defined by the one or more virtual markers.
